(19) United States
(12) Patent Application Publication
(10) Pub. No.: US 2023/0261301 A1
(43) Pub. Date: Aug. 17, 2023

(54) BATTERY PACK

(71) Applicant: JIANGSU DONGCHENG TOOLS TECHNOLOGY CO., LTD., NANTONG (CN)

(72) Inventor: XINGANG JI, NANTONG (CN)

(21) Appl. No.: 18/303,547

(22) Filed: Apr. 19, 2023

Related U.S. Application Data
(63) Continuation of application No. PCT/CN2022/111983, filed on Aug. 12, 2022.

(30) Foreign Application Priority Data
Aug. 26, 2021 (CN) 202122038139.3
Jun. 17, 2022 (CN) 202210687030.9

(51) Int. Cl. H01M 50/213; H01M 10/42; H01M 50/262

(52) U.S. Cl. CPC H01M 50/213; H01M 10/4257; H01M 50/262

(57) ABSTRACT

A battery pack, including a housing and at least one battery assembly disposed within the housing; wherein each battery assembly includes a plurality of cells and a cell bracket connected to longitudinal ends of the plurality of cells; wherein along a longitudinal view, the plurality of cells are divided into at least two single-row cell sets, and axes of cells in each single-row cell set are on a same arc of a circular arc; axes of two adjacent cells in one of the at least two single-row cell sets are in a triangular shape with an axis of a corresponding cell in another of the at least two single-row cell sets, the one of the at least two single-row cell sets being adjacent to the another of the at least two single-row cell sets.

### CROSS REFERENCE TO RELATED APPLICATIONS

The present disclosure is a continuation-application of International (PCT) Patent Application No. PCT/CN2022/111983, filed on Aug. 12, 2022, which claims priority of Chinese Patent Application No. 202210687030.9, filed on Jun. 17, 2022, and No. 202122038139.3, filed on Aug. 26, 2021, the entire contents of which are hereby incorporated by reference in their entirety.

### TECHNICAL FIELD

The present disclosure relates to the field of power tools, and in particular to a battery pack.

### BACKGROUND

At present, the lithium-ion battery pack with nominal voltage higher than 36V on the market is mostly connected in parallel with two groups, such as a battery pack with nominal voltage of 50.4V, which has a larger number of cells (28 cells), making the volume of the whole pack relatively large. In addition, the unreasonable arrangement of the cells in the battery pack makes the temperature difference between the cells under high current discharge; after long time use, it is easy to lead to the poor consistency of the cells, which causes the discharge capacity of the battery pack to be reduced and the life time to be lowered. Moreover, when the battery pack has more than two rows of cells, the inner cells are surrounded by other cells; during high-power discharge, the outer cells all have surface contact with outer air, and their heat dissipation effect is better, while the heat dissipation effect of the inner cells is worse, which will cause a large temperature difference between the inner and outer cells. Especially during the high-power discharge, the temperature rise rate is fast and the temperature difference is more obvious.

In view of this, there is a real need to provide an improved battery pack to overcome the defects of the related art.

### SUMMARY OF THE DISCLOSURE

In view of the shortcomings of the related art, the present disclosure aims to provide a miniaturized, easy-to-combine/expand battery pack with the advantages of stable and reliable internal structure and uniform heat dissipation of the cells.

To solve the above technical problems, the present disclosure provides a battery pack, comprising a housing and at least one battery assembly disposed within the housing; wherein each battery assembly comprises a plurality of cells and a cell bracket connected to longitudinal ends of the plurality of cells; wherein along a longitudinal view, the plurality of cells are divided into at least two single-row cell sets, and axes of cells in each single-row cell set are on a same arc of a circular arc; axes of two adjacent cells in one of the at least two single-row cell sets are in a triangular shape with an axis of a corresponding cell in another of the at least two single-row cell sets, the one of the at least two single-row cell sets being adjacent to the another of the at least two single-row cell sets.

To solve the above technical problems, the present disclosure further provides a battery pack, comprising a housing and a battery assembly disposed within the housing; wherein the housing comprises an upper housing and a lower housing that are vertically arranged; the upper housing defines an air inlet, the lower housing defines an air outlet, and the at battery assembly is disposed between the air inlet and the air outlet; the battery assembly comprises a plurality of cells and a cell bracket connected to longitudinal ends of the plurality of cells; along a longitudinal view, the plurality of cells are divided into at least two single-row cell sets, and axes of cells in each single-row cell set are on a same arc of a circular arc; in each adjacent two of the at least two single-row cell sets, each cell in an upper single-row cell set is vertically opposite to a corresponding cell in a lower single-row cell set; a line connecting an axis of the cell in the upper single-row cell set and an axis of the corresponding cell in the lower single-row cell set is parallel to a vertical direction.

To solve the above technical problems, the present disclosure further provides a battery pack, comprising a housing and a battery assembly disposed within the housing; wherein the battery assembly comprises a plurality of cells and a cell bracket connected to longitudinal ends of the plurality of cells; along a longitudinal view, the plurality of cells are divided into at least two single-row cell sets, and axes of cells in each single-row cell set are on a same arc of a circular arc; a gap space between four adjacent cells in a middle section of the at least two single-row cell sets is larger than a gap space between four adjacent cells in an outer section of the at least two single-row cell sets on corresponding arcs.

Other objects, advantages and novel features of the invention will become more apparent from the following detailed description when taken in conjunction with the accompanying drawings.

### BRIEF DESCRIPTION OF THE DRAWINGS

The specific embodiments of the present disclosure are described in further detail below in conjunction with the accompanying drawings.

FIG. 1 is a perspective schematic view of a battery pack according to an embodiment of the present disclosure.

FIG. 2 is a partially exploded view of the battery pack shown in FIG. 1.

FIG. 3 is an exploded schematic view of a battery assembly in the battery pack shown in FIG. 2.

FIG. 4 is a front view of the battery assembly shown in FIG. 3.

FIG. 5 is a front view of cells in the battery pack shown in FIG. 4.

### DETAILED DESCRIPTION

The terminology used in the present disclosure is for the purpose of describing particular embodiments only, and is not intended to limit the present disclosure. For example, the following terms such as “up”, “down”, “forward”, “back”, etc., indicating orientation or positional relationships are based only on the orientation or positional relationships shown in the accompanying drawings and are intended only to facilitate and simplify the description of the present disclosure, not to indicate or imply that a device/element referred to must have a particular orientation or be constructed and operated in a particular orientation, and therefore are not to be construed as limiting the present disclosure.

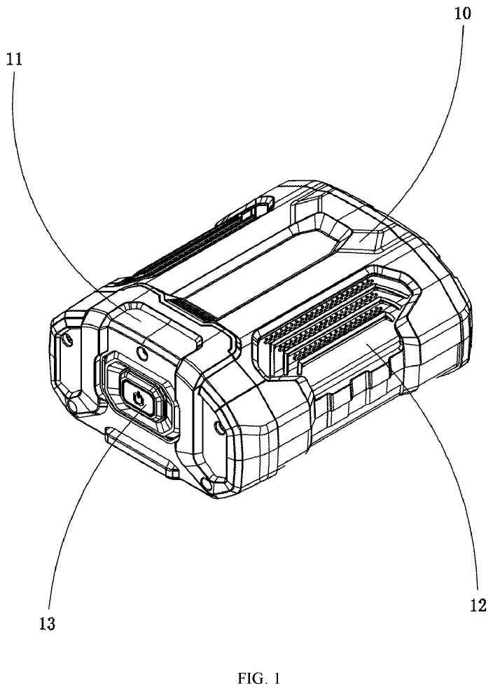

Reference is made to FIGS. 1 to 5 for a battery pack 100 involved in some embodiments of the present disclosure, the battery pack 100 being typically configured to be connected to a power tool, in particular a handheld power tool (not shown). The battery pack 100 includes a housing 10 made of plastic and a battery assembly 20 disposed within the housing 10. In the embodiments, the battery pack 100 includes at least two battery assemblies 20 disposed inside the housing 10 along a longitudinal or transverse direction.

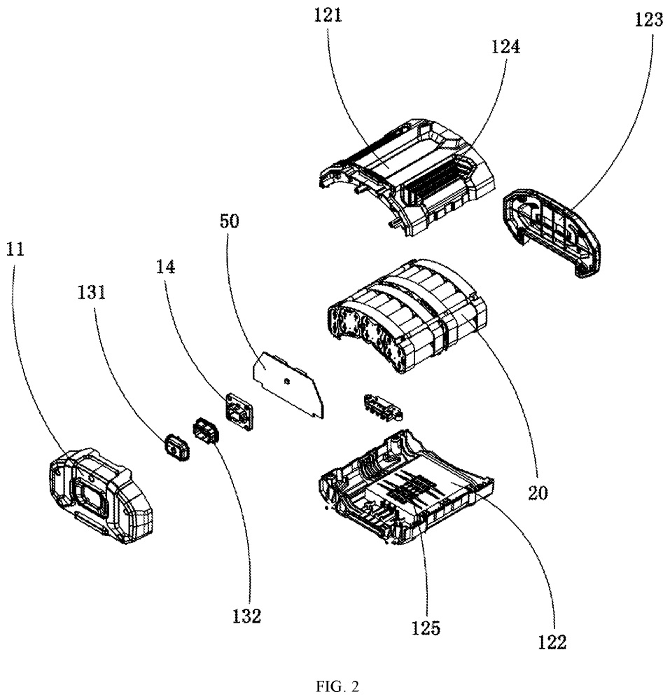

Referring to FIG. 2, the housing 10 includes a first housing 11 and a second housing 12 interlocked, the first housing 11 and the second housing 12 cooperating with each other to define a housing cavity (not shown), and the battery assembly 20 is accommodated in the housing cavity. The first housing 11 is arranged at a longitudinal front end of the battery module 20. The second housing 12 is arranged with an upper housing 121, a lower housing 122, and a rear housing 123, the upper housing 121 being vertically opposite to the lower housing 122, the rear housing 123 being connected to a longitudinal rear end of the upper housing 121 and a longitudinal rear end of the lower housing 122, and the upper housing 121, the lower housing 122, and the rear housing 123 together forming the barrel-shaped second housing 12. The upper housing 121 defines an air inlet 124, the lower housing 122 defines an air outlet 125, and the battery assembly 20 is disposed between the air inlet 124 and the air outlet 125. External air flows into the housing 10 from the air inlet 124 and flows out from the air outlet 125 after flowing through a gap between cells 30 of the battery assembly 20, thereby making the battery assembly 20 have better heat dissipation effect.

The battery pack 100 further includes a switch assembly 13 disposed on the first housing 11 and a light source 14 and a circuit board 50 disposed in the first housing 11, the light source 14 being an LED lamp and being connected and fixed to the circuit board 50. The switch assembly 13 includes a button 131 exposed from the first housing 11 and a holder 132 connected to a longitudinal rear end of the button 131, the holder 132 being fixed to a longitudinal front end of the light source 14 to support the button 131 on the longitudinal front end of the light source 14. The button 131 is made of a light-transmitting material and is disposed adjacent to the light source 14. Light from the light source 14 is emitted from the button 131 out of the first housing 11 to display a current charge level possessed by the battery pack 100 on the button 131.

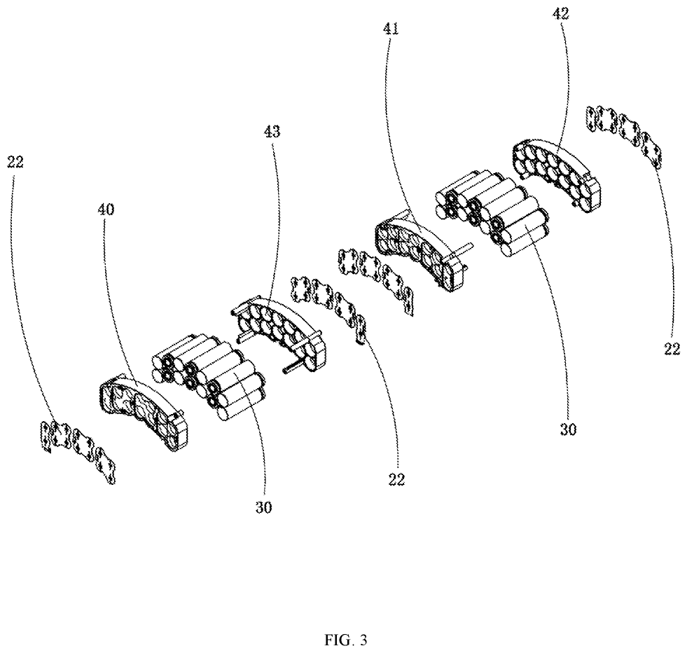

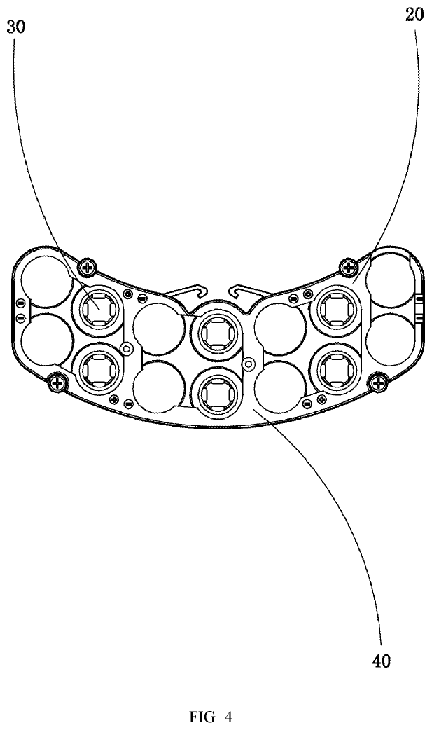

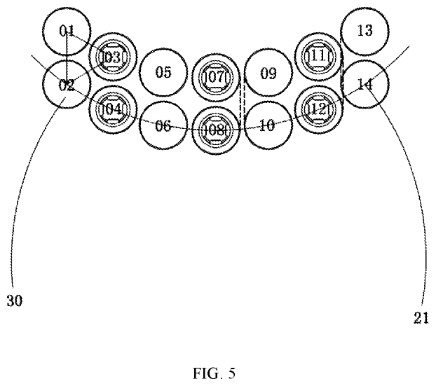

Referring to FIGS. 3 to 4, the battery assembly 20 includes multiple cells 30 extending along the longitudinal direction, a cell bracket 40 connected to longitudinal ends of the cells 30, and multiple electrode sheets 22 disposed at both longitudinal ends of the cell bracket 40. As shown in conjunction with FIG. 5, the multiple cells 30 are arranged along the transverse direction perpendicular to the longitudinal direction into at least two single-row cell sets 21, and at least two single-row cell sets 21 are stacked in the vertical direction. In each single-row cell set 21, axes of the cells 30 are on the same arc of a circular arc; i.e., the at least two single-row cell sets 21 are each arranged in an arc shape when viewed along the longitudinal direction. Such a setting makes the arrangement of the cells 30 in the battery pack 100 compact and the overall space reasonably utilized so as to make the internal structure of the battery assembly 20 stable and secure; in addition, the arc-shaped setting also allows the single-row cell sets 21 to be stacked and expanded.

In some embodiments, the number of the single-row cell sets 21 is two, and the axes of two adjacent cells 30 of one single-row cell set 21 are set in a triangular shape with the axis of a cell 30 of the other single-row cell set 21. This triangular staggered setting solves the problem of high temperature and large temperature difference of the inner cells in the existing cell arrangement, i.e., reducing the temperature difference between the cells 30 and making the heat dissipation of the cells 30 uniform, which is conducive to the equalization of the cells 30 in the battery pack 100.

The cell bracket 40 includes a first bracket 41 and a second bracket 42 respectively disposed at the longitudinal ends of the single-row cell sets 21, the first bracket 41 being arranged with a pin post extending toward the second bracket 42, and the second bracket 42 being arranged with a mating portion facing the pin post. The pin post is connected to the mating portion such that the first bracket 41 and the second bracket 42 are connected to each other to fix the multiple cells 30, thereby fixing the multiple cells 30 to form a stable battery assembly 20.

The cell bracket 40 defines multiple mounting slots 43 running along the longitudinal direction and through the first bracket 41 and the second bracket 42 and hooks (not marked) disposed on the second bracket 42, and the longitudinal ends of the cells 30 are accommodated in the mounting slots 43 and exposed on an outer surface of the cell bracket 40. The battery pack 100 is further arranged with a row of wires (not shown) disposed in the housing 10 and connected between at least two battery assemblies 20 to connect the two battery assemblies 20 in series or in parallel; further, the row of wires is further configured to connect other parts to the circuit board 50. The electrode sheets 22 are fixedly connected to the outer surface of the cell bracket 40 and are affixed to the longitudinal ends of the cells 30 to connect the cells 30 in the battery assembly 20 in series or parallel. The hook 44 is configured to snap the row of wires to make the structure within the battery pack 100 neatly laid out.

In some embodiments, the cells 30 in the two adjacent single-row cell sets 21 are arranged opposite to each other vertically. A line connecting the axis of a cell in an upper single-row cell set 21 and the axis of a corresponding cell in a lower single-row cell set 21 is parallel to the vertical direction. The lines form multiple cell columns extending vertically, with a gap extending vertically between two adjacent cell columns, and along the arc direction, the sizes of the gaps are decreased from the middle section to outer sections. In addition, the battery assembly 20 is disposed between the air inlet 124 and the air outlet 125, such that the gap is connected to the air inlet 124 and the air outlet 125. The external air flows into the housing 10 from the air inlet 124 and out of the air outlet 125 after flowing through the gap between the cell columns of the battery assembly 20, thereby enabling the battery assembly 20 to have better heat dissipation effect. Since the middle section is wrapped, the cells 30 are prone to higher temperature relative to the outer section. The present disclosure sets the cells 30 with an enlarged arrangement of gaps, which is more conducive to the heat dissipation of the cells 30 in the middle section.

Further, referring to FIG. 5 again, in the multiple rows of cell sets, a gap space between four adjacent cells 30 located in the middle section is larger than a gap space between four adjacent cells 30 in the outer section on corresponding two arcs, thereby allowing the cells 30 located in the middle section to dissipate heat faster and thus reducing the temperature difference. Assume that the codes of the cells 30 are respectively 01-14, the experimental data results of the temperature rise of the corresponding cells 30 in the battery assembly 20 when discharged at an ambient temperature of 25° C. for 288 seconds are found experimentally and can be known by the following table.

The highest average temperature of single cell 30 is 104.588° C., and the maximum temperature difference between cells is 4.537° C., indicating that the temperature consistency between cells 30 is good, i.e., the temperature difference between cells 30 is reduced, which makes the heat dissipation of cells 30 uniform and is conducive to the equalization of the cells 30 in the battery pack 100. The experimental data can be concluded that the temperature difference of the cells within the battery pack is not large, which indicates that the increased gap arrangement of the cells is conducive to the heat dissipation of the cells in the middle section, preventing the high temperature of the cells from affecting the use of the product and prolonging the service life. Further, there is also no need to wrap the cells with heat dissipation materials, which further reduces the manufacturing cost.

| No. | Temperature |
|---|---|
| 01 | 100.051 |
| 02 | 101.798 |
| 03 | 103.848 |
| 04 | 102.939 |
| 05 | 104.038 |
| 06 | 103.442 |
| 07 | 104.588 |
| 08 | 103.491 |
| 09 | 104.088 |
| 10 | 103.439 |
| 11 | 103.857 |
| 12 | 102.963 |
| 13 | 100.072 |
| 14 | 101.797 |

The following table shows the temperature rise data of a battery assembly formed by three single-row cell sets 21 together when discharged at an ambient temperature of 25° C. for 500 seconds. The cells in the bottom single-row cell set are coded from left to right as 01 to 07, the cells in the middle single-row cell set are coded from left to right as 08 to 14, and the cells in the top single-row cell set are coded from left to right as 15 to 21.

| No. | Temperature |
|---|---|
| 01 | 80.8492 |
| 02 | 85.1994 |
| 03 | 85.1282 |
| 04 | 85.3513 |
| 05 | 85.4128 |
| 06 | 85.1931 |
| 07 | 80.8433 |
| 08 | 84.9779 |
| 09 | 88.3395 |
| 10 | 87.8760 |
| 11 | 87.8667 |
| 12 | 88.2608 |
| 13 | 88.3488 |
| 14 | 85.0009 |
| 15 | 82.7063 |
| 16 | 84.2131 |
| 17 | 84.4331 |
| 18 | 84.3901 |
| 19 | 84.4052 |
| 20 | 84.2125 |
| 21 | 82.7129 |

Each two adjacent cells 30 in each row cell set in the battery pack define a gap, and the sizes of the gaps gradually increase from the outer section to the middle section. In existing battery packs with more than two rows of cells, if the spacing between adjacent cells is uniform, the temperature of the cell disposed at the very center is the highest, while the temperature of the cell further to the edge is lower, which is extremely unfavorable to the heat dissipation of the battery pack. In the present embodiments, the gaps between adjacent cells 30 are non-uniform, and the gap between cells 30 disposed in the middle section is larger, while the gap between cells 30 disposed in the outer section is smaller, which is conducive to heat dissipation. As can be seen from the temperature rise data in the table above, the highest temperature cell 30 is no longer the cell disposed in the very center, but the cells 30 disposed on both sides (code 9 and 13) have the highest temperature. Therefore, it is confirmed that the temperature difference between the cells 30 may be effectively reduced, such that the heat dissipation of the cells 30 is uniform, which is conducive to the equalization of the cells 30 in the battery pack 100.

In the present disclosure, along the longitudinal view, at least two single-row cell sets 21 are each in an arc shape, and the axis of each cell 30 in one of the single-row cell sets 21 is arranged in a triangular shape with the axes of corresponding adjacent two cells 30 in the other single-row cell set 21. Such a setting makes the arrangement of the cells 30 in the battery pack 100 compact and the overall space reasonably utilized in order to make the structure stable and secure. In addition, the arc-shaped setting also allows the single-row cell sets 21 to be stacked and expanded. The external air flows into the housing 10 from the air inlet 124 and out of the air outlet 125 after flowing through the gaps between the cell columns of the battery assembly 20, thereby making the battery assembly 20 have a better heat dissipation effect. Further, each two adjacent cells 30 define a gap, and the sizes of the gaps gradually increase from the outer section to the middle section, which also solves the problem of high temperature and large temperature difference of the inner cells in the existing cell arrangement, i.e., the temperature difference between the cells 30 is reduced, which makes the heat dissipation of the cells 30 uniform and facilitates the equalization of the cells 30 in the battery pack 100.

The present disclosure is not limited to the above specific implementation. Those skilled in the art can easily understand that there are many alternatives to the battery pack of the present disclosure without departing from the principle and scope of the present disclosure. The scope of the present disclosure is subject to the content of the claims.

What is claimed is:

1. A battery pack, comprising:
a housing; and
at least one battery assembly disposed within the housing; wherein each battery assembly comprises a plurality of cells and a cell bracket connected to longitudinal ends of the plurality of cells;
wherein along a longitudinal view, the plurality of cells are divided into at least two single-row cell sets, and axes of cells in each single-row cell set are on a same arc of a circular arc; axes of two adjacent cells in one of the at least two single-row cell sets are in a triangular shape with an axis of a corresponding cell in another of the at least two single-row cell sets, the one of the at least two single-row cell sets being adjacent to the another of the at least two single-row cell sets.

2. The battery pack according to claim 1, wherein the plurality of cells are arranged along a transverse direction perpendicular to a longitudinal direction and divided into the at least two single-row cell sets, and at least two single-row cell sets are stacked in a vertical direction perpendicular to the transverse direction and the longitudinal direction.

3. The battery pack according to claim 1, wherein the cell bracket comprises a first bracket disposed on one of the longitudinal ends of the plurality of cells and a second bracket disposed on the other of the longitudinal ends of the plurality of cells, the first bracket and the second bracket being connected to each other to fix the plurality of cells.

4. The battery pack according to claim 3, wherein the first bracket is arranged with a pin post extending toward the second bracket, and the second bracket is arranged with a mating portion facing the pin post; the pin post is connected to the mating portion such that the first bracket and the second bracket are connected to each other to fix the plurality of cells.

5. The battery pack according to claim 3, wherein the cell bracket defines a plurality of mounting slots running along a longitudinal direction and through the first bracket and the second bracket, and the longitudinal ends of the plurality of cells are accommodated in the plurality of mounting slots and exposed on outer surfaces of the cell bracket.

6. The battery pack according to claim 5, wherein each battery assembly further comprises a plurality of electrode sheets disposed at both longitudinal ends of the cell bracket; the plurality of electrode sheets are fixedly connected to the outer surfaces of the cell bracket and are affixed to the longitudinal ends of the plurality of cells.

7. The battery pack according to claim 1, wherein the housing comprises a first housing and a second housing interlocked, the first housing and the second housing cooperating with each other to define a housing cavity, and the at least one battery assembly is accommodated in the housing cavity.

8. The battery pack according to claim 7, wherein the number of the at least one battery assembly is at least two, and the at least one battery assembly are disposed in the housing along a longitudinal or transverse direction.

9. The battery pack according to claim 7, further comprising a button disposed on the first housing and a light source disposed within the first housing; wherein the button is made of a light-transmitting material and is disposed adjacent to the light source; light from the light source is emitted from the button out of the first housing.

10. The battery pack according to claim 7, wherein the second housing is arranged with an upper housing and a lower housing that are vertically opposite to each other; the upper housing defines an air inlet, the lower housing defines an air outlet, and the at least one battery assembly is disposed between the air inlet and the air outlet.

11. The battery pack according to claim 1, wherein in each adjacent two of the at least two single-row cell sets, each cell in an upper single-row cell set is vertically opposite to a corresponding cell in a lower single-row cell set; a line connecting an axis of the cell in the upper single-row cell set and an axis of the corresponding cell in the lower single-row cell set is parallel to a vertical direction.

12. The battery pack according to claim 11, wherein the axis of the cell in the upper single-row cell set and the axis of the corresponding cell in the lower single-row cell set are connected to form a cell column; a gap extending vertically is defined between each adjacent two the cell columns; the gap is connected to the air inlet and the air outlet; the gaps are distributed along a row, and sizes of the gaps gradually increase from an outer section to a middle section of the row.

13. A battery pack, comprising
a housing; and
a battery assembly disposed within the housing;
wherein the housing comprises an upper housing and a lower housing that are vertically arranged;
the upper housing defines an air inlet, the lower housing defines an air outlet, and the at battery assembly is disposed between the air inlet and the air outlet; the battery assembly comprises a plurality of cells and a cell bracket connected to longitudinal ends of the plurality of cells;
wherein along a longitudinal view, the plurality of cells are divided into at least two single-row cell sets, and axes of cells in each single-row cell set are on a same arc of a circular arc; in each adjacent two of the at least two single-row cell sets, each cell in an upper single-row cell set is vertically opposite to a corresponding cell in a lower single-row cell set; a line connecting an axis of the cell in the upper single-row cell set and an axis of the corresponding cell in the lower single-row cell set is parallel to a vertical direction.

14. The battery pack according to claim 13, wherein the axis of the cell in the upper single-row cell set and the axis of the corresponding cell in the lower single-row cell set are connected to form a cell column; a gap extending vertically is defined between each adjacent two the cell columns; the gap is connected to the air inlet and the air outlet; the gaps are distributed along a row, and sizes of the gaps gradually increase from an outer section to a middle section of the row.

15. The battery pack according to claim 13, wherein the cell bracket comprises a first bracket disposed on one of the longitudinal ends of the plurality of cells and a second bracket disposed on the other of the longitudinal ends of the plurality of cells, the first bracket and the second bracket being connected to each other to fix the plurality of cells.

16. The battery pack according to claim 15, wherein the cell bracket defines a plurality of mounting slots running along a longitudinal direction and through the first bracket and the second bracket, and the longitudinal ends of the plurality of cells are accommodated in the plurality of mounting slots and exposed on outer surfaces of the cell bracket.

17. The battery pack according to claim 16, wherein each battery assembly further comprises a plurality of electrode sheets disposed at both longitudinal ends of the cell bracket; the plurality of electrode sheets are fixedly connected to the outer surfaces of the cell bracket and are affixed to the longitudinal ends of the plurality of cells.

18. The battery pack according to claim 13, further comprising a button disposed on the first housing and a light source disposed within the first housing; wherein the button is made of a light-transmitting material and is disposed adjacent to the light source; light from the light source is emitted from the button out of the first housing.

19. A battery pack, comprising:
a housing; and
a battery assembly disposed within the housing;
wherein the battery assembly comprises a plurality of cells and a cell bracket connected to longitudinal ends of the plurality of cells;
wherein along a longitudinal view, the plurality of cells are divided into at least two single-row cell sets, and axes of cells in each single-row cell set are on a same arc of a circular arc; a gap space between four adjacent cells in a middle section of the at least two single-row cell sets is larger than a gap space between four adjacent cells in an outer section of the at least two single-row cell sets on corresponding arcs.
